(19) United States
(12) Patent Application Publication
(10) Pub. No.: US 2010/0226678 A1
(43) Pub. Date: Sep. 9, 2010

(54) IMAGE FORMING APPARATUS

(75) Inventors: Ryuichi SATO, Kanagawa (JP); Osamu Tamura, Kanagawa (JP); Noriyoshi Tsuchiya, Kanagawa (JP); Yoshiyuki Takaishi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/697,311

(22) Filed: Feb. 1, 2010

(30) Foreign Application Priority Data
Mar. 4, 2009 (JP) 2009-050437

(51) Int. Cl. G03G 15/00; B65H 5/00; B65H 7/02

(52) U.S. Cl. 399/81; 271/3.19; 271/3.17; 271/3.16; 399/397

(57) ABSTRACT

An image forming apparatus includes: an image forming unit that forms an image on a first sheet; a fixing unit that fixes the image on the first sheet; a discharging unit that discharges the first sheet and a second sheet; a first transporting path that transports the first sheet on which the image is fixed to the discharging unit; a branch path that is branched from the first transporting path downstream of the fixing unit in a sheet transporting direction, the first sheet being transported to the branch path from the first transported path; a second transporting path that transports the second sheet in a direction opposite to the sheet transporting direction to the discharging unit; a plurality of sheet stock units in which sheets are stocked; a first sheet feed unit that feeds the first sheet from at least one of the plurality of sheet stock units to the first transporting path; and a second sheet feed unit that feeds the second sheet from at least one of the plurality of sheet stock units to the second transporting path.

### CROSS-REFERENCE TO RELATED APPLICATIONS

This application is based on and claims priority under 35 USC 119 from Japanese Patent Application No. 2009-050437 filed Mar. 4, 2009.

### BACKGROUND

### Technical Field

The present invention relates to an image forming apparatus for forming an image on a sheet.

### SUMMARY

According to an aspect of the present invention, there is provided an image forming apparatus including: an image forming unit that forms an image on a first sheet; a fixing unit that fixes the image on the first sheet; a discharging unit that discharges the first sheet and a second sheet; a first transporting path that transports the first sheet on which the image is fixed to the discharging unit; a branch path that is branched from the first transporting path downstream of the fixing unit in a sheet transporting direction, the first sheet being transported to the branch path from the first transported path; a second transporting path that transports the second sheet in a direction opposite to the sheet transporting direction to the discharging unit; a plurality of sheet stock units in which sheets are stocked; a first sheet feed unit that feeds the first sheet from at least one of the plurality of sheet stock units to the first transporting path; and a second sheet feed unit that feeds the second sheet from at least one of the plurality of sheet stock units to the second transporting path.

### BRIEF DESCRIPTION OF THE DRAWINGS

Exemplary embodiments of the present invention will be described in detail based on the following figures, wherein:

FIG. 1 is a diagram showing the construction of an image forming system to which an exemplary embodiment is applied;

FIG. 2 is a diagram showing an image forming apparatus according to a first exemplary embodiment;

FIG. 3 is a diagram showing the image forming apparatus;

FIG. 4 is a diagram showing a state under which a first transporting unit and a second transporting unit have been installed in the image forming apparatus;

FIG. 5 is a diagram showing an image forming apparatus according to a second exemplary embodiment; and

FIG. 6 is a diagram showing the image forming apparatus in which a first transporting unit has been installed.

### DETAILED DESCRIPTION

Exemplary embodiments according to the present invention will be described hereunder with reference to the accompanying drawings.

### First Exemplary Embodiment

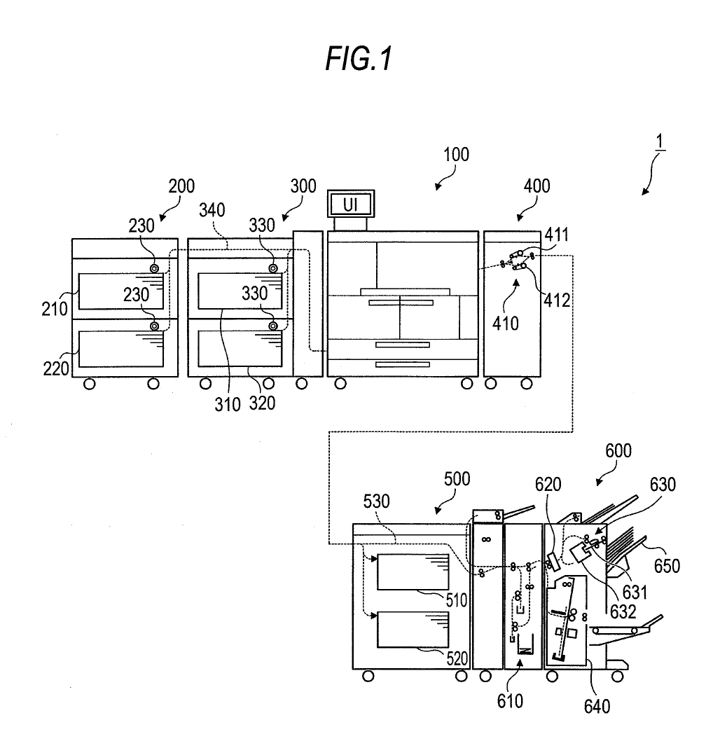

FIG. 1 is a diagram showing the construction of an image forming system to which an exemplary embodiment is applied.

The image forming system 1 of the exemplary embodiment has an image forming apparatus 100 for forming an image on paper as an example of a sheet, a first paper feed apparatus 200 for feeding paper to the image forming apparatus 100, and a second paper feed device 300 that is disposed at a downstream side of the first paper feed device 200 with respect to the paper transporting direction and feeds paper to the image forming apparatus 100. Furthermore, the image forming system 1 has a curl correcting device 400 for correcting curl (warp) of paper transported from the image forming apparatus 100, a paper stack device 500 for stacking paper transported from the curl correcting device 400, and a paper processing device 600 for executing a predetermined processing on paper passed through the paper stacking device 500. Here, the first paper feed device 200 and the second paper feed device 300 can be treated as external sheet feed devices for feeding paper (sheets) to a receiving portion 171 (described later) of the image forming apparatus 100.

The first paper feed device 200 has a first paper stock unit 210 and a second paper stock unit 220 in which paper (sheets) is stocked. The first paper feed device 200 is further provided with a feed-out roll 230 for feeding out paper stocked in the first stock unit 210 and the second stock unit 220 to a transporting path connected to the image forming apparatus 100.

The second paper feed device 300 has the same configuration as the first paper feed device 200, and is provided with a first paper stock unit 310 and a second paper stock unit 320 in which paper (sheets) is stocked. Furthermore, the second paper feed device 300 is provided with a feed-out roll 330 for feeding out paper stocked in the first stock unit 310 and the second stock unit 320 to the transporting path connected to the image forming apparatus 100. The second paper feed device 300 has a transporting path 340 for transporting paper fed from the first paper feed device 200 to the image forming apparatus 100.

The curl correcting device 400 has a curl correcting unit 410 for correcting curl of paper discharged from the image forming apparatus 100. Omitting detailed description, the curl correcting unit 410 has an upper-curl correcting unit 411 for correcting an upper curl which occurs in paper (both the end portions of the paper in the paper transporting direction warp face up) when the paper passes through a fixing unit (described later) of the image forming apparatus 100, and also a down-curl correcting unit 412 for correcting a down curl occurring in paper (both the end portions of the paper in the paper transporting direction warp face down) when the paper passes through the fixing unit.

When the upper curl occurs in the paper, the upper-curl correcting unit 411 applies force (press force) to the upper-curl paper so that the paper concerned is bent to the opposite side to the upper-curl side, thereby correcting the upper curl. Furthermore, when the down curl occurs in the paper, the down-curl correcting unit 412 applies force (press force) to the down-curl paper so that the paper concerned is bent to the opposite side to the down-curl side, thereby correcting the down curl.

The paper stack device 500 has a first paper stack unit 510 for stacking paper (sheets) transported from the curl correcting device 400. The paper stack device 500 has a second paper stack unit 520 at the lower side of the first paper stack unit 510. The paper stack device 500 has a transporting path 530 for transporting paper from the curl correcting device 400 to the paper processing device 600.

The paper processing device 600 has a folding device 610 for subjecting a folding processing such as an internal three-folding (C folding), external three-folding or the like to paper passing through the paper stack device 500. Furthermore, the paper processing device 600 is provided with a perforating unit 620 for perforating (punching) paper, a side stitching unit 630 for stitching the ends of a stack of paper (sheets) by using a staple to create a booklet, and a saddle-stitching unit 640 for center-folding/saddle stitching a stack of paper (sheets) to create a center-page spread booklet. In this case, for example when plural sheets of paper are subjected to staple processing to create a booklet, plural sheets of paper are stacked on a compile tray 631 provided to the side stitching unit 630, and the staple processing is executed by a staple head 632. The paper stack formed as a booklet through the staple processing is discharged to the paper stacking unit 650 provided to the paper processing device 600.

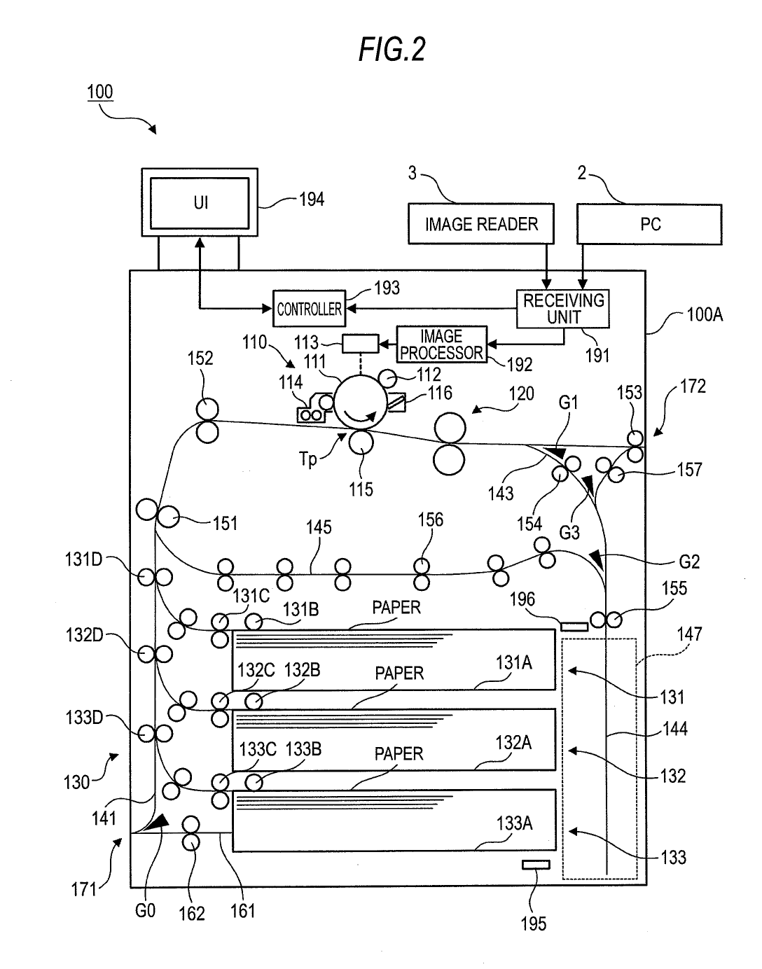

Next, the image forming apparatus 100 will be described with reference to FIG. 2.

FIG. 2 is a diagram showing the image forming apparatus 100.

As shown in FIG. 2, the image forming apparatus 100 has an image forming unit 110 for forming a toner image on paper (a sheet), and also has a fixing unit 120 for fixing the toner image formed on the paper in the image forming unit 110 so that the toner image is fixed onto the paper. The fixing unit 120 heats and pressurizes the paper and the toner image to fix the toner image onto the paper. Furthermore, the image forming apparatus 100 has a receiving unit 171 for receiving paper transported from the first paper feed device 200 or the second paper feed device 300. The image forming apparatus 100 further has a first paper transporting path 141 for passing the paper received by the receiving unit 171 through the image forming unit 110 and the fixing unit 120 and then transporting the paper to a paper discharge unit 172. The image forming apparatus 100 also has a paper feeder 130 for feeding paper to the first paper transporting path 141.

The image forming apparatus 100 is further provided with a third paper feed path 161 which is provided so as to be branched from the first paper transporting path 141 and transports paper received by the receiving unit 171 to a site at which a third paper stock unit 133A described later is provided. The image forming apparatus 100 is further provided with a switching gate G0 (an example of a switching unit) for switching the paper transporting destination to the first paper transporting path 141 or the third paper transporting path 161, and a driving source (not shown) such as a solenoid or the like for driving the switching gate G0. The image forming apparatus 100 is also provided with a transporting roll 162 which is provided in the third paper transporting path 161 and transports paper along the third paper transporting path 161.

The image forming unit 110 has a photoconductor drum 111, an electrifying device 112, an exposure device 113, a developing device 114, a transfer device 115 and a cleaning device 116. The photoconductor drum 111 has a photoconductive layer on the outer peripheral surface thereof and rotates in the direction of an arrow in FIG. 2. The electrifying device 112 electrifies the rotating photoconductor drum 111 so that the potential of the photoconductor drum 111 is set to a predetermined potential. The exposure device 113 selectively exposes to light the photoconductor drum 111 which is electrified at the predetermined potential by the electrifying device 112, thereby forming an electrostatic latent image.

The developing device 114 develops the electrostatic latent image formed on the photoconductor drum 111 with toner to form a toner image. The transfer device 115 electrostatically transfers the toner image formed on the photoconductor drum 111 to paper transported along the first paper transporting path 141. The cleaning device 116 cleans toner, etc. remaining on the photoconductor drum 111 after the transfer. A position at which the photoconductor drum 111 and the transfer device 115 are opposed to each other and a toner image on the photoconductor drum 111 is transferred onto paper by using the transfer device 115 is referred to as transfer position Tp.

The paper feeding unit 130 has a first paper feeder 131, a second paper feeder 132 and a third paper feeder 133. In this exemplary embodiment, the third paper feeder 133 is disposed at the lowermost position, the second paper feeder 132 is disposed above the third paper feeder 133, and the first paper feeder 131 is disposed above the second paper feeder 132. Additionally describing, the third paper feeder 133 is disposed at the most upstream side, and the first paper feeder 131 is disposed at the most downstream side with respect to the paper transporting direction.

The first paper feeder 131 has a first paper stock unit 131A, a first pull-in roller 131B and a first handling mechanism 131C.

Here, the first paper stock unit 131A as an example of a sheet stock unit has a rectangular parallelepiped shape opened at the upper portion thereof, accommodates paper (sheets) therein. The first paper stock unit 131A is provided so that it can be pulled to the front side (forwardly in FIG. 2). Accordingly, when the first paper stock unit 131A is out of paper or the like, the first paper stock unit 131A is pulled out from the image forming apparatus 100, and paper can be replenished to the first paper stock unit 131A. The first paper stock unit 131A is further pulled to the front side (forwardly in FIG. 2), whereby the first paper stock unit 131A can be detached form the image forming apparatus 100 (the device main body 100A).

The first pull-in roll 131B is provided above the first paper stock unit 131A so as to be movable in the up-and-down direction. The first pull-in roll 131B comes into contact with the uppermost paper of a stack of paper (sheets) stocked in the first paper stock unit 131A, and feeds out the uppermost paper to the first handling mechanism 131C.

The first handling mechanism 131C is provided at the downstream side of the first pull-in roll 131B with respect to the paper transporting direction. The first handling mechanism 131C is constructed by a rotatable field roll and a rotation-restricted retard roll, and it handles sheets of paper fed out from the first pull-in roll 131B one by one and feeds out each handled sheet of paper to a first transporting roll 131D described later.

The second paper feeder 132 also has the same configuration as the first paper feeder 131, and is equipped with a second paper stock unit 132A, a second pull-in roll 132B and a second handling mechanism 132C. Furthermore, the third paper feeder 133 as an example of the paper feeder has the same configuration as the first paper feeder 131, and is equipped with a third paper stock unit 133A (an example of the sheet stock unit), a third pull-in roll 133B and a third handling mechanism 133C.

Furthermore, the paper feeder 130 is equipped with a first feeding roll 131D, a second feeding roll 132D and a third feeding roll 133D.

The first feeding roll 131D is constructed by a pair of roll-shaped members, and provided at the downstream side of the first handling mechanism 131C with respect to the paper transporting direction. The first transporting roll 131D temporarily stops paper fed from the first handling mechanism 131C, and then feeds the paper at a predetermining timing again. The second transporting roll 132D is also constructed by a pair of roll-shaped members. This second transporting roll 132D is provided at the downstream side of the second handling mechanism 132C with respect to the paper transporting direction, and it temporarily stops paper fed from the second handling mechanism 132C and then feeds the paper at a predetermining timing again.

Furthermore, the third transporting roll 133D is also constructed by a pair of roll-shaped members. The third transporting roll 133D is provided at the downstream side of the third handling mechanism 133C with respect to the paper transporting direction, and it temporarily stops paper fed from the third handling mechanism 133C and then feeds the paper at a predetermined timing again.

When paper is supplied from each of the second paper feeder 132 and the third paper feeder 133, the first transporting roll 131D and the second transporting roll 132D at the upper stage of these second and third paper feeders 132 and 133 function as transporting rolls for transporting this paper along the first paper transporting path 141.

Furthermore, in the image forming apparatus 100 of this exemplary embodiment, a pre-registration roll 151 and a registration roll 152 are provided to the first paper transporting path 141 to be located at the downstream side of the first transporting roll 131D. Here, the pre-registration roll 151 further transports paper transported through the first transporting roll 131D to the downstream side, and forms a loop in cooperation with the registration roll 152. Furthermore, the registration roll 152 temporarily stops and thus temporarily stops the transportation of the paper, and resumes its rotation in conformity with the timing, whereby the paper is transported to the transfer position Tp while executing registration adjustment.

The image forming apparatus 100 is provided with a reversing and feeding mechanism for reversing one-side-fixed paper fixed in the fixing unit 120 and feeding the paper to the transfer position Tp again when the both side mode is selected. This reversing and feeding mechanism has a first branch path 143 downwardly branched from the first paper transporting path 141 at the downstream side of the fixing unit 120 with respect to the paper transporting direction. The reversing and transporting mechanism is provided so as to be connected to the first branch path 143, and it is equipped with a second paper transporting path 144 which extends downwardly from the connection portion with the first branch path 143 and directs from the above connection portion to a paper discharge unit 172. Furthermore, the reversing and transporting mechanism is provided with a return path 145 which is connected to the second paper feeding path 144 and joined to the first paper transporting path 141 at the upstream side of the pre-registration roll 151.

In the image forming apparatus 100, a paper discharge roll 153 for discharging paper to the outside of the apparatus is provided in the first paper transporting path 141. The image forming apparatus 100 has a branch roll 154 that is provided in the first branch path 143 and transports paper transported to the first branch path 143 to the second paper transporting path 144, and also has a reversing roll 155 that is forwardly and reversely rotatable, temporarily feeds the paper transported to the second paper transporting path 144 downwardly (in one direction), and reversely rotates to feed the paper into the return path 145 or transports the paper along the second paper transporting path 144. A space (site) 147 in which paper is downwardly fed is formed at the lower side of the reversing roll 155. This space 147 is provided in proximity to the first paper feeder 131, the second paper feeder 132 and the third paper feeder 133 of the paper feeder 130.

The image forming apparatus 100 has a return roll 156 that is provided in the return path 145 and transports the paper transported by the reversing roll 155 along the return path 145. The image forming apparatus 100 also has a transporting roll 157 for transporting the paper in the second paper transporting path 144 to the paper discharge unit 172, and the transporting roll 157 is located so as to be nearer to the paper discharge unit 172 than the connection portion between the first branch path 143 and the second paper transporting path 144.

Although omitted from the foregoing description, the image forming apparatus 100 of this exemplary embodiment is configured so that paper (sheet) having an image formed thereon can be discharged to the outside of the apparatus while both the sides thereof are reversed. In this case, the paper passing through the fixing unit 120 is fed through the first branch path 143 into the second paper transporting path 144. Thereafter, the paper is guided to the second paper transporting path 144 and then transported to the discharge unit 172.

A first switching gate G1 for switching the paper transportation destination to the first paper transporting path 141 and the first branch path 143 is provided between the first paper transporting path 141 or the first branch path 143. Furthermore, a second switching gate G2 for switching the paper transportation destination to the return path 145 or the second paper transporting path 144 is provided between the second paper transporting path 144 and the return path 145. Furthermore, a third switching gate G3 for transporting paper fed to the second paper transporting path 144 into the paper discharge unit 172 is provided between the first branch path 143 and the second paper transporting path 144. The image forming apparatus 100 is also provided with a driving source (not shown) such as a solenoid or the like for driving the first switching gate G1 to the third switching gate G3.

Furthermore, the image forming apparatus 100 of this exemplary embodiment is equipped with a receiver 191 for receiving image data from a personal computer (PC) 2, an image reader 3 or the like, and an image processor 192 for subjecting the image data received by the receiver 191 to image processing and then outputting the processed image data to the exposure device 113. The image forming apparatus 100 is also equipped with a controller 193 for controlling the respective devices and the respective units provided to the image forming apparatus 100 and also controlling the overall image forming system 1 of this exemplary embodiment.

The image forming apparatus 100 has a user interface (UI) 194 (an example of a display unit and an accepting unit) that is constructed by a display panel, accepts an instruction (information) from a user and displays a message or the like for the user). The controller 193 functioning as one of the speed controller and the apparatus controller has CPU (Central Processing Unit), ROM (Read Only Memory) and RAM (Random Access Memory). CPU executes the processing according to the program stored in ROM while receiving/transmitting data from/to RAM, thereby implementing respective functions described later.

Furthermore, the image forming apparatus 100 of this exemplary embodiment is provided with a first read-out unit 195 that is provided below the third paper stock unit 133A and reads out information from an EEPROM (Electrically Erasable and Programmable ROM) mounted in a first transporting unit 700 described later. In addition, a second read-out unit 196 for reading out information from EEPROM (Electrically Erasable and Programmable ROM) mounted in a second transporting unit 800 described later is provided above the space 147. Here, the first read-out unit 195 may be regarded as a type of detecting unit for detecting mounting of the first transporting unit 700. Furthermore, the second read-out unit 196 may be regarded as a type of detecting unit for detecting mounting of the second transporting unit 800.

Here, the image forming system 1 of this exemplary embodiment is provided with the side stitching unit 630 and the saddle-stitching unit 640 as described above, and thus a booklet including plural sheets of paper can be created. There is a case where a printed front cover or a printed rear cover is separately added when such a booklet is created. Furthermore, there is also a case where printed paper is inserted between sheets of paper constituting a booklet. There is also a case where ornamented paper on which gold foil or silver foil is impressed is used as a front cover, a rear cover or insertion paper to be inserted between sheets of paper. In this specification, the front cover, the rear cover, the insertion paper, the ornamented paper, etc. will be referred to as “additional paper” in some cases.

When such additional paper is added, the paper passing through the fixing unit 120 may be lowered in quality due to heat of the fixing unit 120. Specifically, the degree of brilliancy of an image may be lowered. When gold foil or silver foil is formed as described above, the degree of brilliancy of this gold foil or silver foil may be lowered.

Therefore, when additional paper is added, it is possible that the additional paper is fed into the paper transporting path at the downstream side of the image forming apparatus 100. In such a case, in addition to the paper feeding device for feeding paper (sheets) to the image forming apparatus 1 (corresponding to the first paper feeding device 200 and the second paper feeding device 300 in this exemplary embodiment), a paper feeding device is required to be further provided at the downstream side of the image forming apparatus 100. As a result, the image forming system must be designed in a large scale. Therefore, the image forming system 1 of this exemplary embodiment adopts the following configuration.

In the image forming apparatus 100 of the image forming system 1 according to this exemplary embodiment, the third paper stock unit 133A is detachably mounted as described above. Furthermore, the space 147 for feeding paper downwardly is formed at the lower side of the reversing roll 155. The space 147 is provided to be adjacent to the first paper feeder 131, the second paper feeder 132 and the third paper feeder 133 of the paper feeder 130. Therefore, in the image forming apparatus 100 of this exemplary embodiment, a paper transporting path along which paper (sheets) is not passed through the fixing unit 120 is formed by using a space (site) 148 formed after the third paper stock unit 133A is detached and the space 147 located below the reversing roll 155.

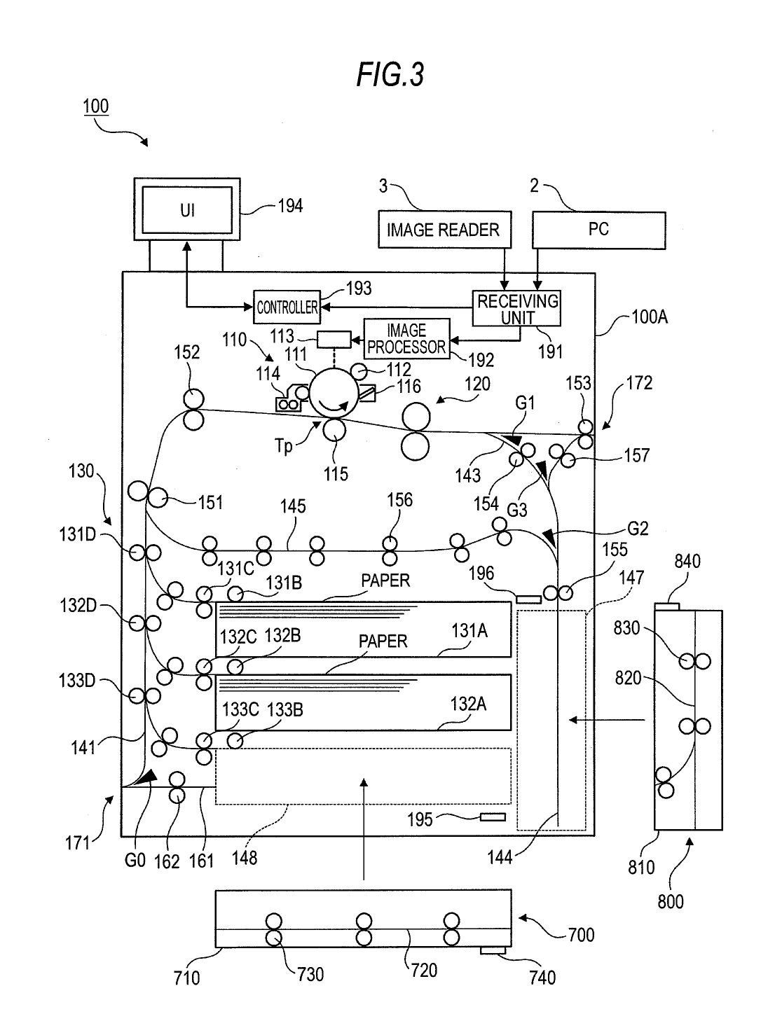

FIG. 3 is a diagram showing the image forming apparatus 100.

As shown in FIG. 3, when the third paper stock unit 133A (see FIG. 2) is detached from the image forming apparatus 100, the space 148 is formed at the position where the third paper stock unit 133A has been mounted just before. In this exemplary embodiment, a first transporting unit 700 which can be fitted to (inserted into) this space 148 is prepared.

The first transporting unit 700 has a rectangular parallelepiped unit body 710. A unit transporting path 720 to which paper is transported is provided in the unit body 710. Furthermore, the first transporting unit 700 has plural transporting rolls 730 for transporting paper along the unit transporting path 720. The transporting rolls 730 can be rotated by using the driving force transmitted from the image forming apparatus 100 side. The first transporting unit 700 may be provided with a driving source such as a motor or the like so that the transporting rolls 730 can be rotated by the driving source. The first transporting unit 700 has EEPROM 740 as an example of a memory in which various kinds of information are stored.

Furthermore, in this exemplary embodiment, a second transporting unit 800 which can be fitted (inserted) in the space 147 formed below the reversing roll 155 is prepared. The second transporting unit 800 has a rectangular parallelepiped unit body 810. A unit transporting path 820 to which paper is transported is provided in the unit body 810. The second transporting unit 800 is also equipped with plural transporting rolls 830 for transporting paper along the unit transporting path 820.

The transporting rolls 830 can be rotated by using the driving force transmitted from the image forming apparatus 100 side. However, the second transporting unit 800 may be provided with a driving source such as a motor or the like so that the transporting rolls 830 can be rotated by the driving source. The second transporting unit 800 has EEPROM 840 as an example of a memory in which various kinds of information are stored.

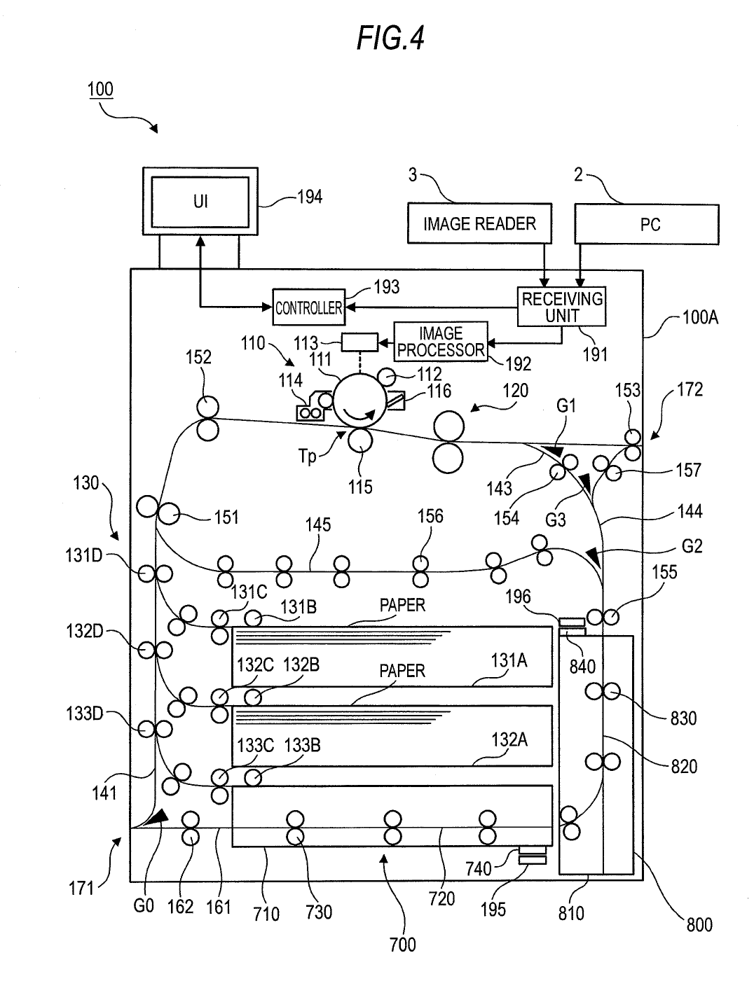

Here, FIG. 4 shows the image forming apparatus 100 under the state that the first transporting unit 700 and the second transporting unit 800 are mounted in the image forming apparatus 100.

As shown in FIG. 4, when the first transporting unit 700 is mounted in the image forming apparatus 100, the unit transporting path 720 in the first transporting unit 700 is set to be connected to the third paper transporting path 161 provided to the image forming apparatus 100.

Furthermore, when the second transporting unit 800 is mounted in the image forming apparatus 100, the unit transporting path 820 in the second transporting unit 800 is set to be connected to the unit transporting path 720 in the first transporting unit 700. In addition, the unit transporting path 820 in the second transporting unit 800 is set to be connected to the second paper transporting path 144 in the image forming apparatus 100.

When the first transporting unit 700 is mounted in the image forming apparatus 100, information stored in EEPROM 740 is read out by the first read-out unit 195. When the second transporting unit 800 is mounted in the image forming apparatus 100, information stored in an EEPROM 840 is read out by the second read-out unit 196. Accordingly, on the basis of the read-out information, the controller 193 can recognize that the first transporting unit 700 and the second transporting unit 800 are mounted in the image forming apparatus 100.

Here, when the controller 193 recognizes that the first transporting unit 700 and the second transporting unit 800 are mounted in the image forming apparatus 100, the controller 193 displays, on UI 194 , a screen for accepting a condition for adding additional paper from a user. Specifically, the screen for accepting information concerning an insertion position of additional paper, etc. is displayed on UI 194. Additionally describing, the display of UI 194 is changed to accept the additional-paper adding condition from the user. The controller 193 does not display the above screen when the controller 193 does not recognize that the first transporting unit 700 and the second transporting unit 800 are mounted.

Furthermore, the controller 193 accepts from the user through UI 194 the information concerning a paper stock unit in which additional paper is stocked (the first paper stock unit 210, the second paper stock unit 220, the first paper stock unit 310 or the second paper stock unit 320 (see FIG. 1)). Accordingly, the controller 194 can identify the paper stock unit in which the additional paper (sheets) is stocked.

Furthermore, when the controller 193 recognizes that the first transporting unit 700 and the second transporting unit 800 are mounted, the controller 193 changes the display of UI 194 so as to make it possible to set the condition which has been impossible to be set before the first transporting unit 700 and the second transporting unit 800 are mounted. For example, when various kinds of settings cannot be performed with respect to paper (sheets) having a thickness exceeding some upper limit value because it is difficult to fix such thick paper in the fixing unit 120, the display of UI 194 is changed so that these various kinds of settings can be performed with respect to paper having a thickness exceeding the upper limit value. That is, even in the case of paper having a thickness larger than some upper limit value, it can be transported while bypassing a bypass transporting path described later. Therefore, the display of UI 194 is changed so that various kinds of settings can be performed with respect to paper having a thickness exceeding the upper limit value.

As described above, when the first transporting unit 700 and the second transporting unit 800 are mounted in the image forming apparatus 100, a new paper transporting path is formed by the third paper transporting path 161, the unit transporting path 720, the unit transporting path 820 and the second paper transporting path 144. Additionally describing, the new paper transporting path (hereinafter referred to as “bypass transporting path”) along which paper is not passed through the image forming unit 110 and the fixing unit 120 is formed. Accordingly, the additional paper which should not be passed through the fixing unit 120 can be stocked in the first paper feeding device 200 or the second paper feeding device 300 (see FIG. 1). Additionally describing, paper which should not be passed through the fixing unit 120 can be stocked in the first paper feeding device 200 or the second paper feeding device 300, and it is unnecessary to further provide a paper feeding device at the downstream side of the image forming apparatus 100.

Here, when a booklet is created in the paper processing device 600, the controller 193 accepts through UI 194 information concerning creation of a booklet such as an insertion position, etc. of additional paper. The controller 193 transmits a control signal to the first paper feeding device 200 and the second paper feeding device 300 on the basis of the accepted information. In response to this control signal, paper (sheets) is successively transported from the first paper feeding device 200 and the second paper feeding device 300. Specifically, the paper (sheets) is successively transported from the first paper feeding device 200 and the second paper feeding device 300, and also additional paper (an example of a different sheet) is transported while inserted at the insertion position. When paper on which an image is formed in the image forming unit 110 is transported, the controller 193 drives the switching gate GO and selects the first paper transporting path 141 as a paper transporting destination. Accordingly, the paper is passed through the image forming unit 110 and the fixing unit 120 and also discharged to the outside of the apparatus (the curl correcting device 400) by the paper discharging roll 153.

When additional paper is transported, the controller 193 drives the switching gate G0 to switch the transporting destination of the additional paper to the third paper transporting path 161. Furthermore, the controller 193 drives the switching gate G2 and the switching gate G3 to set the second paper transporting path 144 as a paper transporting path to which the additional paper is transported. Accordingly, the additional paper is passed through the third paper transporting path 161, the unit transporting path 720, the unit transporting path 820 and the second paper transporting path 144 and discharged to the outside of the apparatus. That is, the additional paper is discharged to the outside of the apparatus without passing through the image forming unit 110 and the fixing unit 120.

For example, when there is a difference between the path length of the first paper transporting path 141 (hereinafter referred to as “fixing unit passing transporting path”) passing through the image forming unit 110 and the fixing unit 120 and the path length of the bypass transporting path, the time for which paper passing along the fixing unit passing transporting path is discharged from the image forming apparatus 100 is different from the time for which paper passing along the bypass transporting path is discharged from the image forming apparatus 100. Additionally describing, when sheets of paper are successively transported under the state that paper passing through the fixing unit passing transporting path and paper passing through the bypass transporting path are mixed with each other, the pitch of the sheets of paper which are successively discharged from the image forming apparatus 100 is not uniform.

Therefore, in order to make the paper discharge pitch uniform, the paper transporting speed may be controlled. Additionally describing, the paper transporting speed may be controlled so that the time required until paper passing through the fixing unit passing transporting path reaches the paper discharge unit 172 is equal to the time required until paper passing through the bypass transporting path reaches the paper discharge unit 172. Here, the bypass transporting path side is provided with neither image forming unit 110 nor fixing unit 120. Therefore, the paper transporting speed at the bypass transporting path side is controlled.

### Second Exemplary Embodiment

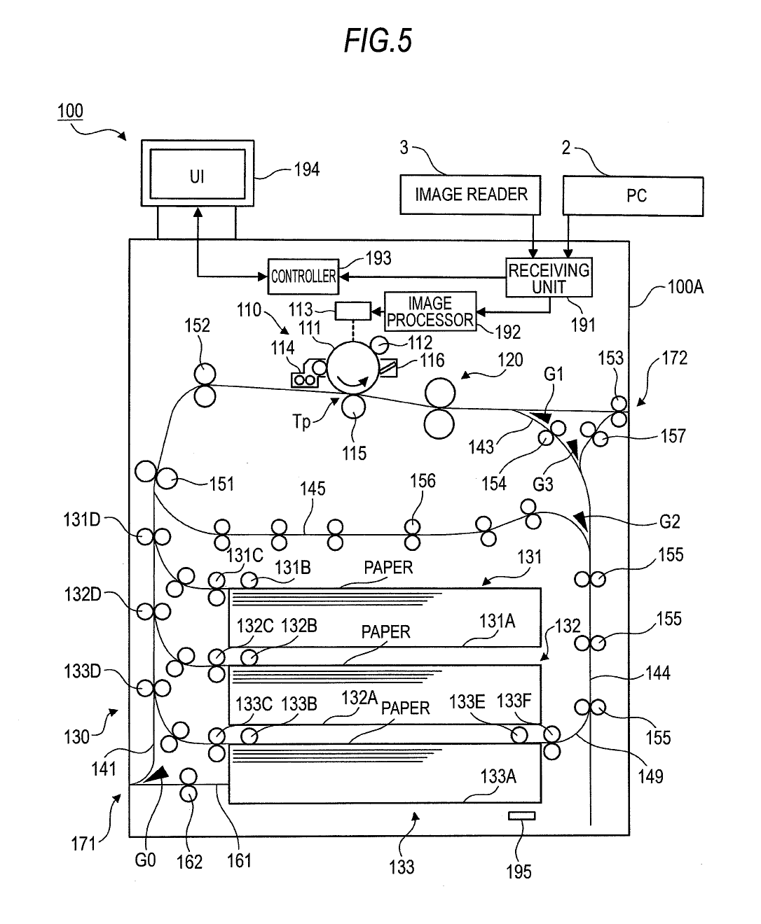

FIG. 5 is a diagram showing an image forming apparatus 100 according to a second exemplary Embodiment. The same functions as the first exemplary embodiment are represented by the same reference numerals, and the description thereof is omitted.

In this exemplary embodiment, plural reversing rolls 155 functioning as transporting units are provided. These reversing rolls 155 are provided in the space 147 (see FIG. 2) in the first exemplary embodiment. Additionally describing, the plural reversing rolls 155 are provided along the second paper transporting path 144. Furthermore, in this exemplary embodiment, a second branch path 149 which is branched from the second paper transporting path 144 and directs to the third paper feeder 133 is provided. The second branch path 149 is branched from the second paper transporting path 144 at the lower side of the reversing roll 155 located at the lowermost position out of the plural reversing rolls 155.

The third paper feeder 133 of this exemplary embodiment is provided with a fourth pull-in roll 133E (an example of a second feeding unit) and a fourth handling mechanism 133F in addition to the third pull-in roll 133B (an example of the first feeding unit) and the third handling mechanism 133C. The fourth pull-in roll 133E and the fourth handling mechanism 133F are provided at the opposite side to the side (the left side in FIG. 5) at which the third pull-in roll 133B and the third handling mechanism 133C are provided. Paper which is fed out by the fourth pull-in roll 133E and handled by the fourth handling mechanism 133F is fed through the second branch path 149 into the second paper transporting path 144.

Therefore, in this exemplary embodiment, the paper which is fed out by the fourth pull-in roll 133E and handled by the fourth handling mechanism 133F is fed to the second paper transporting path 144, and then upwardly transported by the reversing rolls 155. Additionally describing, the paper which is fed out by the fourth pull-in roll 133E and handled by the fourth handling mechanism 133F is discharged through the second branch transporting path 149 and the second paper transporting path 144 to the outside of the image forming apparatus 100. Additionally describing, paper stocked in the third paper feeder 133 can be discharged to the outside of the image forming apparatus without passing through the image forming unit 110 and the fixing unit 120.

Therefore, when the additional paper which should not be passed through the fixing unit 120 is stocked in the third paper feeder 133, the additional paper can be discharged to the outside of the image forming apparatus without passing through the fixing unit 120. Additionally describing, it is likewise unnecessary to provide a paper feeding device at the downstream side of the image forming apparatus 100.

For this exemplary embodiment is also prepared the first transporting unit 700 which can be inserted into the space (site) formed after the third paper stock unit 133A is detached.

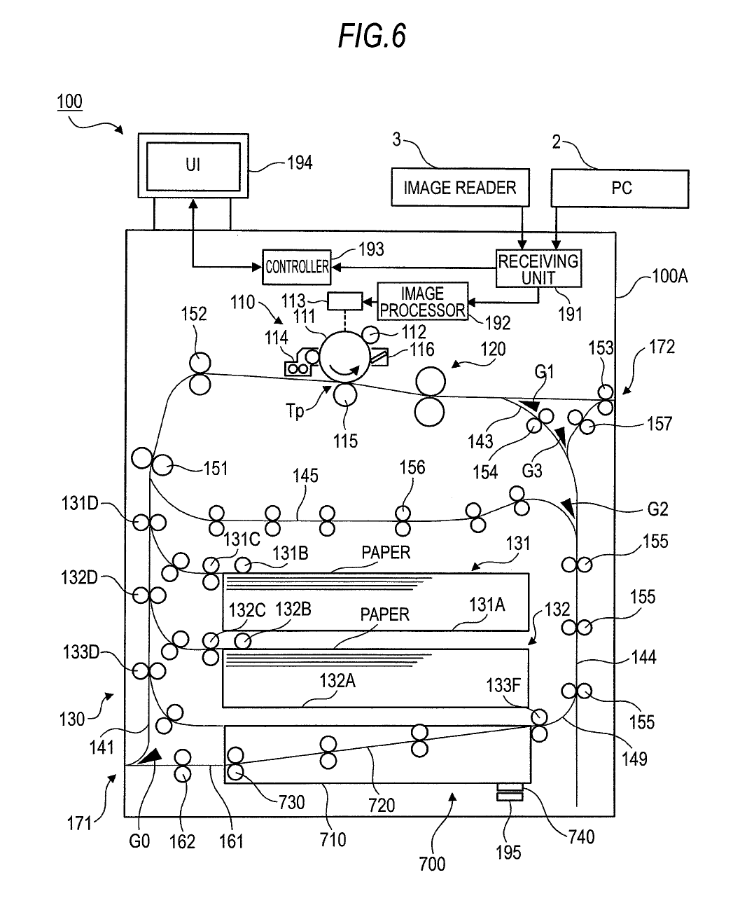

FIG. 6 is a diagram showing the image forming apparatus 100 when the first transporting unit 700 is mounted. As shown in FIG. 6, by mounting the first transporting unit 700, the third paper transporting path 161 and the second branch path 149 are connected to each other. As a result, paper which is transported from the first paper feeding device 200 and the second paper feeding device 300 can be also discharged to the outside of the image forming apparatus 100 without passing through the image forming unit 110 and the fixing unit 120.

When the number of sheets of additional paper which should not be passed through the fixing unit 120 is small, these sheets may be stocked in the third paper feeder 133. On the other hand, when the number of sheets of additional paper is small, there occurs a situation that all the sheets of additional paper cannot be stocked in the third paper feeder 133. In such a case, by mounting the first transporting unit 700, these sheets of additional paper can be stocked in the first paper feeding device 200 having a large volume or the like.

In this exemplary embodiment, when the third paper stock unit 133A is detached, the third pull-in roll 133B (see FIG. 5), the third handling mechanism 133C and the fourth pull-in roll 133E are detached together with the third paper stock unit 133A. Furthermore, in this exemplary embodiment, the second branch path 149 is located at the upper side of the third paper transporting path 161, and thus the unit transporting path 720 in the first transporting unit 700 is obliquely disposed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image forming unit that forms an image on a first sheet;
a fixing unit that fixes the image on the first sheet;
a discharging unit that discharges the first sheet and a second sheet;
a first transporting path that transports the first sheet on which the image is fixed to the discharging unit;
a branch path that is branched from the first transporting path downstream of the fixing unit in a sheet transporting direction, the first sheet being transported to the branch path from the first transported path;
a second transporting path that transports the second sheet in a direction opposite to the sheet transporting direction to the discharging unit;
a plurality of sheet stock units in which sheets are stocked;
a first sheet feed unit that feeds the first sheet from at least one of the plurality of sheet stock units to the first transporting path; and
a second sheet feed unit that feeds the second sheet from at least one of the plurality of sheet stock units to the second transporting path.

2. The image forming apparatus according to claim 1,
further comprising: a main body,
wherein at least one of the plurality of sheet stock units is detachably mounted at a predetermined site in the main body.

3. The image forming apparatus according to claim 2, further comprising:
a transporting unit is configured to be attached to the predetermined site in the main body when the at least one of the plurality of sheet stock units is detached;
a receiving unit that receives the sheet from an external;
a third transporting path that transports the sheet received by the receiving unit to the transporting unit; and
a switching unit that switches a transporting destination of the sheet received by the receiving unit to one of the first transporting path and the third transporting path, wherein the transporting unit transports the sheet transported from the third transporting path to the second transporting path when the switching unit switches to the third transporting path.

4. The image forming apparatus according to claim 3, wherein the second transporting path is provided with a transporting roll that transports the sheet transported from the transporting unit to the discharging unit.

5. An image forming apparatus comprising:
a main body having a receiving unit that receives a first sheet and a second sheet from an external, and a discharging unit that discharges the first sheet and the second sheet;
an image forming unit that forms a image on the first sheet;
a fixing unit that fixes the image on the first sheet;
a first transporting path that transports the first sheet received by the receiving unit to the discharging unit while passing the first sheet through the image forming unit and the fixing unit;
a branch path that is branched from the first transporting path downstream of the fixing unit in a sheet transporting direction, the first sheet being transported from the first transporting path to the branch path;
a second transporting path that transports the second sheet in a direction opposite to the sheet transporting direction to the discharging unit;
a sheet feeder having a sheet stock unit in which sheets are stocked, the sheet stock unit being detachably mounted at a site in the main body, and the sheet feeder feeding the first sheet stocked in the sheet stock unit to the first transporting path;
a transporting unit that is configured to be attached to the site in the main body when the sheet stock unit is detached;
a third transporting path that transports the second sheet received by the receiving unit to the transporting unit; and
a switching unit that switches a transporting destination of a sheet received by the receiving unit to one of the first transporting path and the third transporting path, wherein the transport unit transports the second sheet transported from the third transporting path to the second transporting path when the switching unit switches to the third transporting path.

6. The image forming apparatus according to claim 5, wherein a second transporting unit is configured to be attached to a site where the second transporting path is provided, and transports the second sheet transported from the transporting unit to the discharging unit.

7. The image forming apparatus according to claim 5, further comprising: a plurality of sheet feeders each having the sheet stock unit, and the plurality of sheet feeders each feed a sheet to the first transporting path at a different position in a transporting direction,
wherein the third transporting path transports the sheet to the transporting unit disposed upstream of the plurality of sheet feeders in the transporting direction.

8. The image forming apparatus according to claim 5, further comprising: a speed control unit that controls a transporting speed of the sheet in the third transporting path, the transporting unit and the second transporting path so that the sheet, received by the receiving unit and transported by the transporting unit and the second transporting path, reaches the discharging unit after a predetermined time elapses from receiving the sheet by the receiving unit, the predetermined time being a time elapsing from receiving a sheet by the receiving unit to transporting the sheet by the first transporting path and reaching the discharging unit.

9. The image forming apparatus according to claim 5, further comprising:
a device controller that controls an external sheet feeding device which feeds the sheets to the receiving unit and inserts an insert sheet of a different type from sheets between the sheets;
a display that displays a screen to accept information on an insertion position of the insert sheet;
an accepting unit that accepts the information; and
a detecting unit that detects mounting of the transporting unit, wherein when the detecting unit detects the mounting of the transporting unit, the display displays the screen to accept the information concerning the insertion position.

10. The image forming apparatus according to claim 1, wherein the second transporting path transports the first sheet passed through the branch path in sheet transporting direction and transports the first sheet in a direction opposite to the sheet transporting direction to the discharging unit.

11. The image forming apparatus according to claim 1, wherein at least one of the plurality of sheet stock units is configured to feed the first sheet to the first transporting path and feed the second sheet to the second transporting path.

12. The image forming apparatus according to claim 5, wherein the second transporting path transports the first sheet passed through the branch path in sheet transporting direction and transports the first sheet in a direction opposite to the sheet transporting direction to the discharging unit.
